(19) United States
(12) Patent Application Publication
(10) Pub. No.: US 2017/0324436 A1
(43) Pub. Date: Nov. 9, 2017

(54) METHOD AND APPARATUS FOR RECEIVING DIGITAL RADIO FREQUENCY (RF) SIGNAL

(71) Applicant: Electronics and Telecommunications Research Institute, Daejeon (KR)

(72) Inventors: Kanghee KIM, Daejeon (KR); Sang-Won KIM, Daejeon (KR); Ki Cheol TAE, Daejeon (KR); Yong-Seok CHOI, Daejeon (KR)

(73) Assignee: Electronics and Telecommunications Research Institute, Daejeon (KR)

(21) Appl. No.: 15/584,703

(22) Filed: May 2, 2017

(30) Foreign Application Priority Data
May 3, 2016 (KR) 1020160054840

(51) Int. Cl. H04B 1/18; H04B 1/525; H04B 1/08; H04B 17/21; H04B 7/02; H04B 1/44; H04B 17/14

(52) U.S. Cl. CPC H04B 1/18; H04B 7/02; H04B 1/525; H04B 1/44; H04B 1/086; H04B 17/21; H04B 17/14

(57) ABSTRACT

Disclosed is a digital radio frequency (RF) signal receiving apparatus including an RF filter configured to convert multichannel wireless signals received through an antenna into signals available for digital sampling, an analog-to-digital converter configured to perform digital sampling on the multichannel wireless signals converted by the RF filter, a digital processor configured to perform filtering on each of the digital-sampled multichannel wireless signals into a plurality of bandwidth signals within a maximum bandwidth range simultaneously, and down-convert the filtered multichannel wireless signals to be signals in a baseband, a data formatter configured to format the down-converted signals based on an input/output data form of transmission interfaces, and a data transmitter configured to simultaneously transmit each of formatted signals to a corresponding processing platform.

### CROSS-REFERENCE TO RELATED APPLICATION(S)

This application claims the priority benefit of Korean Patent Application No. 10-2016-0054840 filed on May 3, 2016, in the Korean Intellectual Property Office, the disclosure of which is incorporated herein by reference for all purposes.

### BACKGROUND

### 1. Field

One or more example embodiments relate to a digital receiving apparatus and method of performing digitizing and informatizing by receiving a radio frequency (RF) signal, and more particularly, to a receiving apparatus and method of multiplexing and digitizing a multiband variable bandwidth.

### 2. Description of Related Art

A radio frequency (RF) signal receiving apparatus is being used in various application fields. When the RF signal receiving apparatus is specially designed as a receiving apparatus of a mobile communication terminal, a predetermined transmission interface may be included and data received through the predetermined transmission interface may be transmitted. Here, the transmission interface suitable for a required volume of data is selected. Because the transmission interface is actually implemented by a high speed interface in one hardware platform, a transmission rate may be insignificant. However, a general-purpose receiving apparatus may be used for various purposes such as for radio wave monitoring, direction detecting, and a radar. Also, the general-purpose receiving apparatus may receive an RF signal through a plurality of channels and transmit data to a signal processing system in an application field through a general-purpose interface such as Ethernet.

Analog-to-digital converter (ADC) technology is developing, and accordingly a frequency bandwidth that may be received (digitized) at one time is increasing. However, the frequency bandwidth to be processed at one time may be decreased and swept due to a speed limit of a transmission interface and a signal processing speed in an application field using a multichannel receiving apparatus. In such a sweep process, a bandwidth to be processed at one time may be decreased and a center frequency is frequently changed such that a control complexity may also increase and a minimum amount of time used for setting sweep processing operations (reset of various data paths) may be required.

### SUMMARY

An aspect provides an apparatus and method of receiving a digital radio frequency (RF) signal that enhances a processing frequency bandwidth of a receiving apparatus due to a limit of performance of a neighboring system and a transmission interface and enhances an efficiency of an entire system operation by simultaneously transmitting data corresponding to a level of the neighboring system.

According to an aspect, there is provided a digital radio frequency (RF) signal receiving apparatus including an RF filter configured to convert multichannel wireless signals received through an antenna into signals available for digital sampling, an analog-to-digital converter configured to perform digital sampling on the multichannel wireless signals converted by the RF filter, a digital processor configured to perform filtering on each of the digital-sampled multichannel wireless signals into a plurality of bandwidth signals within a maximum bandwidth range simultaneously, and down-convert the filtered multichannel wireless signals to be signals in a baseband, a data formatter configured to format the down-converted signals based on an input/output data form of transmission interfaces, and a data transmitter configured to simultaneously transmit each of formatted signals to a corresponding processing platform.

According to another aspect, there is provided a method of receiving a digital radio frequency (RF) signal including converting multichannel wireless signals received through an antenna into signals available for digital sampling, performing digital sampling on the converted multichannel wireless signals, performing filtering on each of the digital-sampled multichannel wireless signals into a plurality of bandwidth signals within a maximum bandwidth range simultaneously, and down-convert the filtered multichannel wireless signals to be signals in a base band, formatting the down-converted signals based on an input/output data form of transmission interfaces, and transmitting each of the formatted signals to a corresponding processing platform simultaneously.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a block diagram illustrating a digital radio frequency (RF) signal receiving apparatus according to an example embodiment;

FIGS. 2 and 3 are diagrams each illustrating a digital filter according to an example embodiment;

FIG. 4 is a diagram illustrating a processing platform according to an example embodiment;

FIG. 5 is a diagram illustrating a system in which a digital radio frequency (RF) signal receiving apparatus is connected to a processing platform according to an example embodiment;

FIGS. 6 through 8 are diagrams each illustrating an example of multiband filtering according to an example embodiment;

FIGS. 9A through 9C are diagrams each illustrating a position of a calibrator in a digital processor according to an example embodiment; and

FIG. 10 is a flowchart illustrating a method of receiving a digital radio frequency (RF) signal according to an example embodiment.

### DETAILED DESCRIPTION

When it is determined detailed description related to a related known function or configuration they may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

Hereinafter, embodiments of the present invention will be described in detail with reference to the accompanying drawings. When it is determined detailed description related to a known function or configuration they may render the purpose of the present invention unnecessarily ambiguous in describing the present invention, the detailed description will be omitted here.

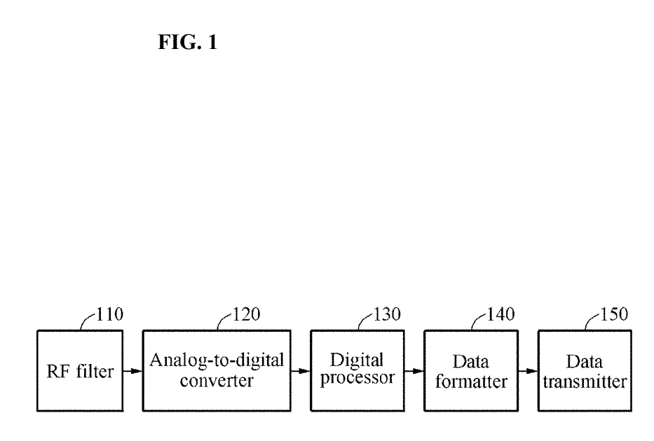

FIG. 1 is a block diagram illustrating a digital radio frequency (RF) signal receiving apparatus according to an example embodiment.

Referring to FIG. 1, the digital RF signal receiving apparatus includes an RF filter 110, an analog-to-digital converter 120, a digital processor 130, a data formatter 140, and a data transmitter 150. However, it is only an example and the present disclosure is not limited thereto. The digital RF signal receiving apparatus may have different configurations based on a frequency band (HF/U/V), a bandwidth (wideband/narrowband) for reception and baseband modulation, a number of channels (one channel/two channels/multiple channels), whether to support synchronization between channels (coherent/noncoherent), a combination of blocks for performing digital processing, or an external connection configuration method.

The RF filter 110 receives an RF signal through an antenna and converts the RF signal into a signal available for digital sampling. The RF filter 110 may include a single RF filter or a plurality of RF filters based on a number of RF channels supported by the digital RF signal receiving apparatus. In an array signal processing application field, multiple channels may be used.

The analog-to-digital converter 120 performs digital sampling on the signal converted by the RF filter 110. The analog-to-digital converter 120 includes a single sub-analog-to-digital converter or a plurality of sub-analog-to-digital converters based on the number of RF channels. Here, at least two sub-analog-to-digital converters may be regarded as including a coherent receiving apparatus when sampling is performed by synchronizing operation times.

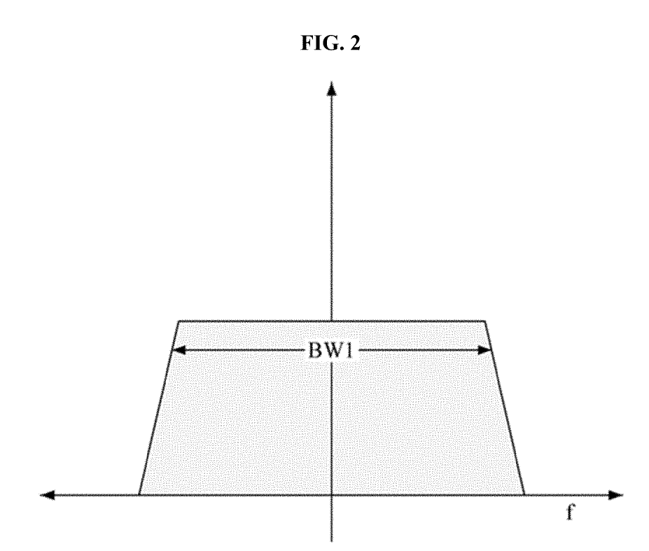

The digital converter 130 includes a digital filter and a down converter. The digital converter 130 may perform filtering on a signal having a relatively high sampling frequency input through the analog-to-digital converter 120 to be a digital signal having a required bandwidth and then prepare a signal for a necessary application process by converting the digital signal into a baseband signal. In an example, the digital processor 130 may perform filtering on each of digital-sampled multichannel wireless signals into a plurality of bandwidth signals within a maximum bandwidth range simultaneously, and down-convert the filtered multichannel wireless signals to be signals in a baseband. Detailed description thereof will be provided with reference to FIGS. 2 through 8. In addition, the digital processor 130 may include a function of performing calibration based on a degree of a mismatch on an RF path.

The data formatter 140 may output and format the signals down-converted by the digital processor 130 based on an input/output data form of transmission interfaces.

The data transmitter 150 may simultaneously transmit each of formatted signals (signals output by the data formatter 140) to a corresponding processing platform.

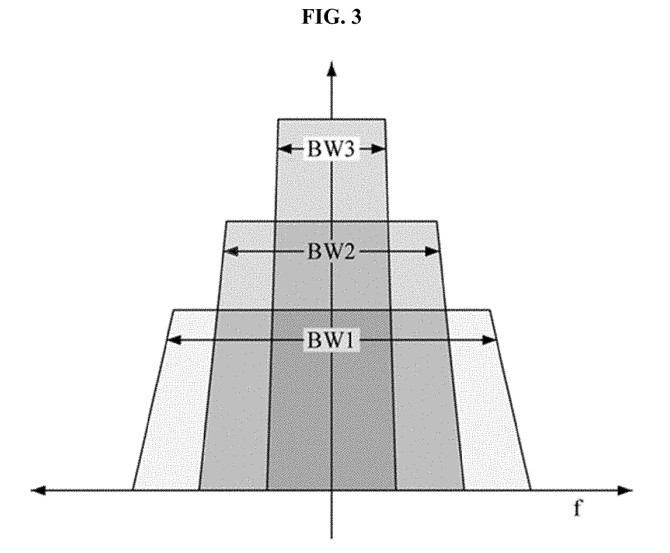

FIGS. 2 and 3 are diagrams each illustrating a digital filter according to an example embodiment.

Conventionally, based on a system design, when a maximum bandwidth to be converted into a baseband is indicated as BW1 for convenience, a number of filters of a multichannel simultaneous receiver may be equal to a number of radio frequency (RF) channels as illustrated in FIG. 2. Here, when a size of BW1 is not increased due to a speed limit or a transmission rate limit of a neighboring application processing platform, an interest band may be not processed at one time such that the band is processed at least two times based on a method of moving a center frequency and processing BW1. The above-described process refers to a sweep process and a temporal signal gap may be caused.

In addition, because a bandwidth available for actual baseband digitization may be provided in plural to be less than or equal to a maximum bandwidth, one of a plurality of digital filters may be selected and used based on a center, for example, BW1, BW2, and BW3, as illustrated in FIG. 3.

A processing speed of a neighboring processing platform which is to use a signal converted into a baseband signal may differ depending on a system level (or version), and a portion of the processing platform may be updated such the processing speed may be enhanced. In addition, not only a transmission rate but also the processing speed may be different for each processing platform.

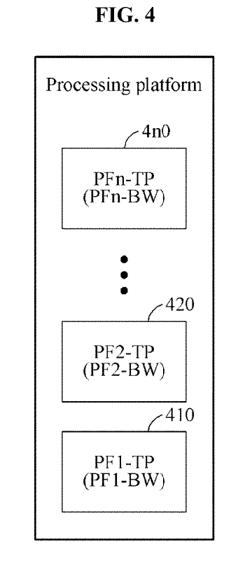

FIG. 4 is a diagram illustrating a processing platform according to an example embodiment.

Referring to FIG. 4, PF1 410, PF2 420, and PFn 4nO indicate a first processing platform 410, a second processing platform 420, and an n-th processing platform 4nO, and each of PF1, PF2 through PFn may have a processible bandwidth of PFn-BW (bandwidth). A size of the bandwidth is determined based on a smaller value between a value of an actual transport bandwidth and a value of a processing speed in an application processing field. To support the processing platforms having different performances, a general system configuration may be assumed in the present disclosure as follows.

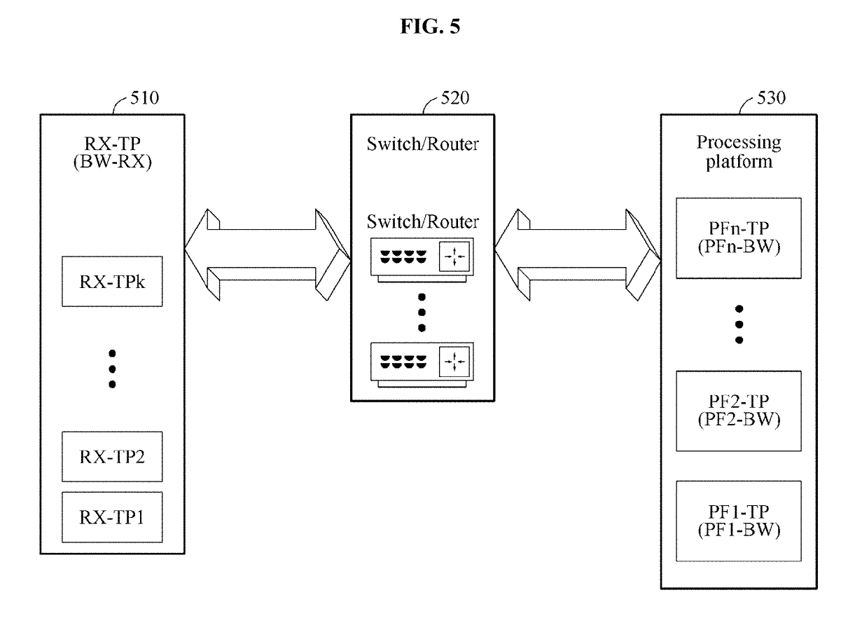

FIG. 5 is a diagram illustrating a system in which a digital radio frequency (RF) signal receiving apparatus is connected to a processing platform according to an example embodiment.

Referring to FIG. 5, RX-TP indicates transmission related modules of a digital RF signal receiving apparatus 510, and BW-RX indicates a transmission bandwidth used for transmission in the digital RF signal receiving apparatus 510. The transmission may be performed through one or a plurality of physical transmission interfaces including a heterogeneous interface. It is assumed that data transmitted by the digital RF signal receiving apparatus 510 is transmitted to a processing platform 530 via a switch/router 520, and the digital RF signal receiving apparatus 510 and the processing platform 530 may be directly connected when one-to-one correspondence between transmission ports of the digital RF signal receiving apparatus 510 and the processing platform 530 is available. Also, the switch/router 520 do not limit a layer and is able to perform switching and routing of L1, L2, and L3 including Ethernet. In addition, it is possible to use a switch/router including a heterogeneous interface or a converter to utilize the heterogeneous interface.

In an above-described system, the digital RF signal receiving apparatus 510 may transmit the data by classifying a transmission type, for example, an internet protocol (IP) or Ethernet, corresponding to a capacity PFn-BW of the processing platform 530. At that time, digital filtering should support a band to be classified and transmitted.

Thus, the digital processor 130 may include a filter for obtaining a signal of a baseband by performing filtering on one band available for being a maximum baseband to be multiple bands instead of a filter of changing and using a bandwidth in one band.

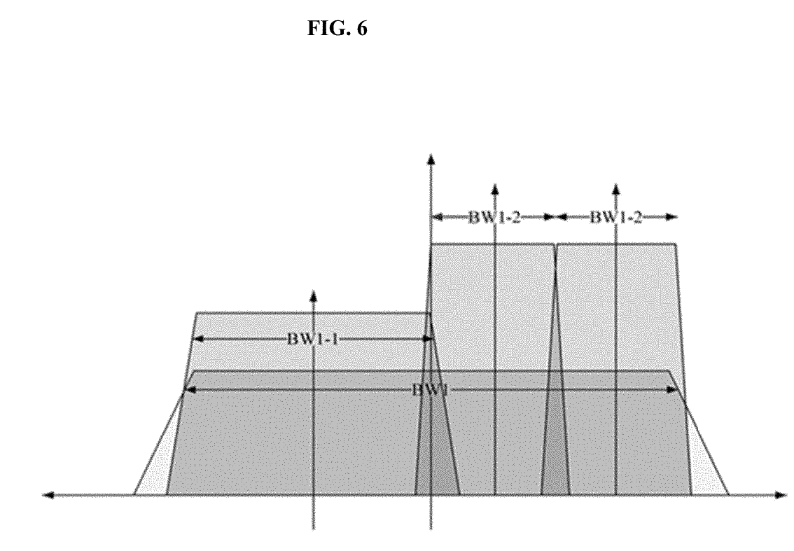

FIGS. 6 through 8 are diagrams each illustrating an example of multiband filtering according to an example embodiment.

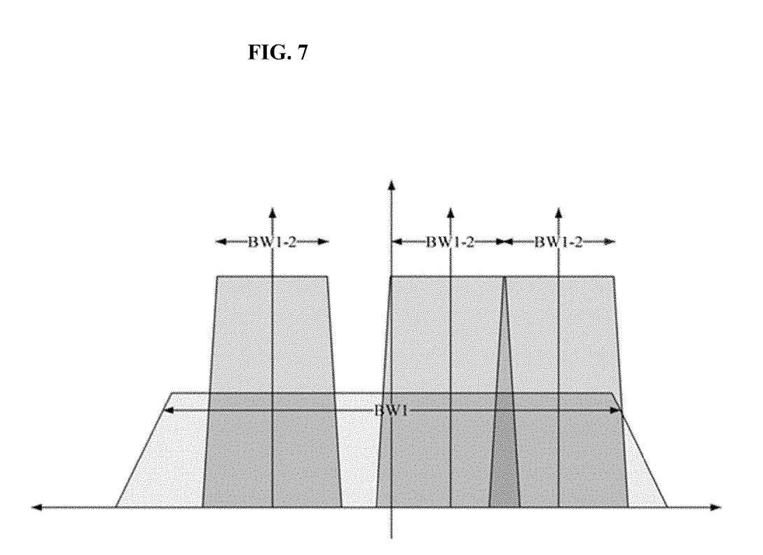

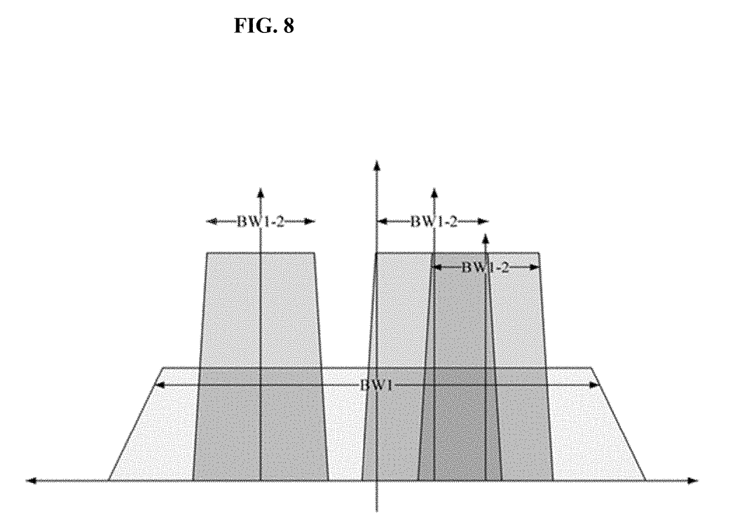

In an example, referring to FIG. 6, the digital processor 130 may perform filtering by including one subband BW1-1 and two subbands BW1-2s within a maximum band BW1 and each of the subbands may be down-converted to be signals in a baseband corresponding to each center frequency. In another example, referring to FIG. 7, the digital processor 130 may extract three subbands BW1-2s within the maximum band BW1. In still another example, referring to FIG. 8, the digital processor 130 may extract two overlapping subbands BW1-2 within the maximum band BW1. However, filtering processes of FIGS. 6 through 8 are only examples. A signal having various bandwidths using a basic structure of digital filtering may be converted into a signal in a baseband corresponding to each center frequency.

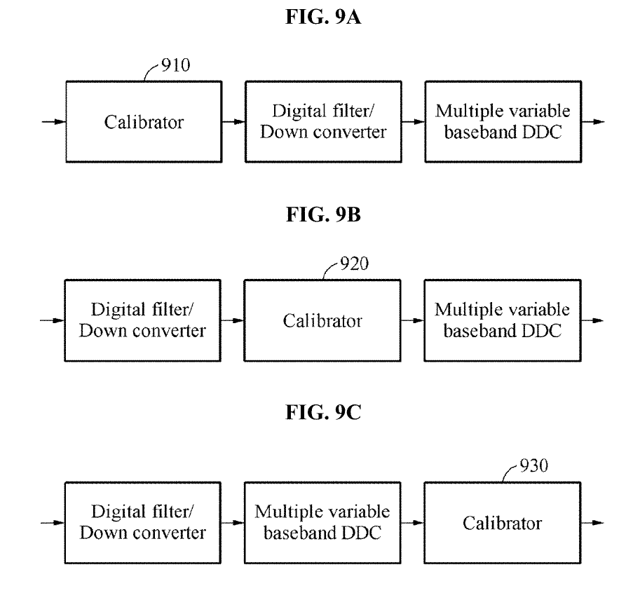

Meanwhile, the digital processor 130 may include a calibration function that compensates for a mismatch error caused between channels of a multichannel receiving apparatus. Various examples of positions of calibrators 910, 920, and 930 are illustrated in FIGS. 9A through 9C.

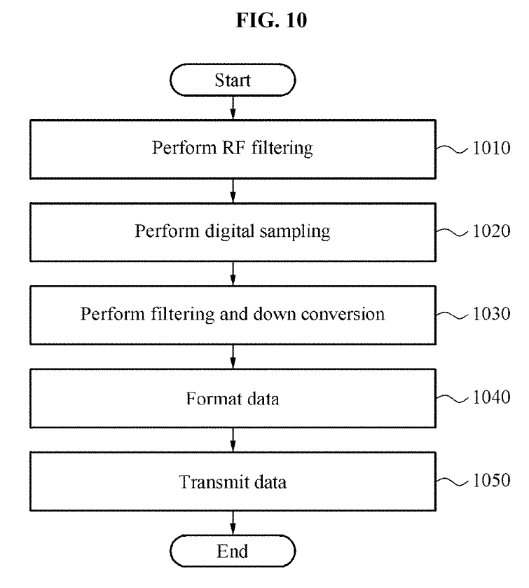

FIG. 10 is a flowchart illustrating a method of receiving a digital radio frequency (RF) signal according to an example embodiment.

Referring to FIG. 10, in operation 1010, a digital RF signal receiving apparatus, hereinafter also referred to as an apparatus, converts multichannel wireless signals received through an antenna into signals available for digital sampling.

Subsequently, in operation 1020, the apparatus performs digital sampling on the converted multichannel wireless signals. Here, sampling may be performed by synchronizing the multichannel wireless signals.

In operation 1030, the apparatus performs filtering on each of the digital-sampled multichannel wireless signals into a plurality of bandwidth signals within a maximum bandwidth range simultaneously, and down-convert the filtered multichannel wireless signals to be signals in a baseband. In an example, the apparatus performs filtering on sub-bandwidths having different sizes within a predetermined maximum bandwidth. In another example, the apparatus performs filtering on, a number of times, on sub-bandwidths having an identical size within the predetermined maximum bandwidth. In still another example, the apparatus performs filtering so that sub-bandwidths are overlapped within the predetermined maximum bandwidth. In addition, the apparatus may perform calibration in response to a mismatch on an RF path in operation 1030.

Subsequently, in operation 1040, the apparatus formats the down-converted signals based on an input/output data form of transmission interfaces. In operation 1050, the apparatus simultaneously transmits each of the formatted signals to a corresponding processing platform. Here, the apparatus may transmit data to a plurality of processing platforms through a switch or a router.

According to example embodiments described herein, a method and a process may enable a receiving apparatus available for a broadband to eliminate a condition in which a processing bandwidth is limited by processing/transmitting performance of a single transmitting/receiving interface and a neighboring application system thereby maximizing a simultaneous baseband processing width and enabling a multiplex transmission through a heterogeneous and a homogeneous interface such that a multiplex transmission with a multiband and a variable bandwidth that increase a system efficiency is possible.

According to example embodiments described herein, a system efficiency may be obtained in addition to an effect of enhancing a calibration feature based on a narrowband calibration effect compared to a maximum band by performing simultaneous baseband modulation and separate transmission on multiple bandwidths.

According to example embodiments described herein, an apparatus and method of simultaneously extracting signals in a multiband from one wide frequency band range from a high speed receiving apparatus including one or multiple transmission interfaces and transmitting the signals to a plurality of object platforms are provided.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A digital radio frequency (RF) signal receiving apparatus, the apparatus comprising:
an RF filter configured to convert multichannel wireless signals received through an antenna into signals available for digital sampling;
an analog-to-digital converter configured to perform digital sampling on the multichannel wireless signals converted by the RF filter;
a digital processor configured to perform filtering on each of the digital-sampled multichannel wireless signals into a plurality of bandwidth signals within a maximum bandwidth range simultaneously, and down-convert the filtered multichannel wireless signals to be signals in a baseband;
a data formatter configured to format the down-converted signals based on an input/output data form of transmission interfaces; and
a data transmitter configured to simultaneously transmit each of formatted signals to a corresponding processing platform.

2. The apparatus of claim 1, wherein the RF filter includes a plurality of RF filters based on a number of channels and the analog-to-digital converter includes a plurality of sub-analog-to-digital converters based on the number of channels.

3. The apparatus of claim 2, wherein the sub-analog-to-digital converters are synchronized each other when the sub-analog-to-digital converters perform digital sampling on the multichannel wireless signals.

4. The apparatus of claim 1, wherein the digital processor is configured to perform filtering on sub-bandwidths having different sizes within a predetermined maximum bandwidth.

5. The apparatus of claim 1, wherein the digital processor is configured to perform filtering, a number of times, on sub-bandwidths having an identical size within a predetermined maximum bandwidth.

6. The apparatus of claim 1, wherein the digital processor is configured to perform filtering so that sub-bandwidths are overlapped within a predetermined maximum bandwidth.

7. The apparatus of claim 1, wherein the digital processor is configured to perform calibration in response to a mismatch on an RF path.

8. The apparatus of claim 1, wherein the data transmitter is configured to transmit data to a plurality of processing platforms through a switch or a router.

9. A method of receiving a digital radio frequency (RF) signal, the method comprising:
converting multichannel wireless signals received through an antenna into signals available for digital sampling;
performing digital sampling on the converted multichannel wireless signals;
performing filtering on each of the digital-sampled multichannel wireless signals into a plurality of bandwidth signals within a maximum bandwidth range simultaneously, and down-convert the filtered multichannel wireless signals to be signals in a base band;
formatting the down-converted signals based on an input/output data form of transmission interfaces; and
transmitting each of the formatted signals to a corresponding processing platform simultaneously.

10. The method of claim 9, wherein the performing digital sampling comprises performing sampling by synchronizing the multichannel wireless signals.

11. The method of claim 9, wherein the performing of filtering comprises performing filtering on sub-bandwidths having different sizes within a predetermined maximum bandwidth.

12. The method of claim 9, wherein the performing of filtering comprises performing filtering, a number of times, on sub-bandwidths having an identical size within a predetermined maximum bandwidth.

13. The method of claim 9, wherein the performing of filtering comprises performing filtering so that sub-bandwidths are overlapped within a predetermined maximum bandwidth.

14. The method of claim 9, wherein the performing of filtering comprises performing calibration in response to a mismatch on an RF path.

15. The method of claim 9, wherein the transmitting comprises transmitting data to a plurality of processing platforms through a switch or a router.
